(19) United States
(12) Patent Application Publication
(10) Pub. No.: US 2018/0300186 A1
(43) Pub. Date: Oct. 18, 2018

(54) METHODS AND APPARATUS FOR CAPTURING AND DETERMINING MAINFRAME OPERATING SYSTEM EVENTS

(71) Applicant: Syncsort Incorporated, Pearl River, NY (US)

(72) Inventor: Charles Grantham, Lincoln, NE (US)

(21) Appl. No.: 15/485,966

(22) Filed: Apr. 12, 2017

(51) Int. Cl. G06F 9/54; G06F 17/30; G06F 11/36

(52) U.S. Cl. CPC G06F 9/542; G06F 11/3612; G06F 17/30321; G06F 17/30516

(57) ABSTRACT

In some embodiments, an apparatus having a memory with processor-executable instructions and a processor operatively coupled to the memory. The apparatus receives a data stream with mainframe operational data. The mainframe operational data includes uncorrelated datasets collected from a mainframe operating system. The apparatus parses the data stream to determine logical relations among uncorrelated datasets indicative of mainframe operating system events. The apparatus generates a record data structure storing the determined logical relations, the related datasets and the indicated mainframe operating system event.

### FIELD

Embodiments described herein relate generally to the analysis of mainframe operational data for the identification of mainframe events.

### BACKGROUND

Mainframes enable mission-critical applications throughout enterprises, by collecting, generating, and processing large data volumes with remarkable performance and reliability. Mainframes excel in processing transactions using bulk processing capacity at high speeds, having an ability to connect large, dispersed networks with diverse components including distributed systems, cloud, Internet of Things (IoT), and other compute devices.

Many enterprises relying on mainframe technologies build data lakes for big data analysis that are isolated from mainframe operational data. These enterprises, however, miss significant pieces of intelligence when mainframe data is not included in such data lakes; an indiscriminate collection of mainframe data is typically not cost-effective because the massive amounts of data generated by mainframes demand high processing power and high storage capacity. This situation results in an underutilization of mainframe data and a diminishment of enterprise investments in big data analytic platforms.

Therefore, a need exists for systems for enterprises and organizations to transfer curated mainframe data to big data platforms, in cost-effective and scalable ways, making mainframe data available for analysis with data collected from other data sources.

### SUMMARY

Embodiments described herein address the need to transfer curated mainframe data configured in formats compatible with big data analytics platforms and other off-device data processing systems. In such embodiments, an apparatus has a memory with processor-executable instructions and a processor operatively coupled to the memory. The processor receives a data stream including datasets with mainframe operational data. Each dataset being uncorrelated to at least one other dataset. The processor parses the data stream to identify a set of datasets and determine a logical relation between at least two datasets. The processor generates a record data structure in a machine-readable format based on the at least two datasets and the logical relation. The data structure includes information indicative of a mainframe operating system.

In another embodiment, a non-transitory computer-readable medium has processor-executable instructions to receive a data stream including datasets with mainframe operational data. Each dataset from the group of datasets being uncorrelated to at least one other dataset. The processor-executable instructions include instructions to parse the data stream to identify a set of datasets and identify a self-supporting dataset from the set of datasets, based on lexical and/or syntactic analysis of the self-supporting dataset. The processor-executable instructions includes instructions to generate a record data structure based on data included in the self-supporting dataset. The data structure includes information indicative of a commencement and termination of a mainframe operating system event.

In yet another embodiment, a computer-based method includes receiving a data stream including datasets with mainframe operational data. Each dataset form the datasets being uncorrelated to at least one other dataset from the group of datasets. The method includes parsing the data stream to identify a set of datasets to then, determine a logical relation between at least two datasets from the identified set of datasets. The method includes generating information indicative of a mainframe operating system event based on the at least two datasets and the logical relation. The method further includes activating an alarm upon a determination that the mainframe operating system event indicates a detrimental performance of at least one mainframe computing resource.

### BRIEF DESCRIPTION OF THE DRAWINGS

FIG. 1 is a schematic diagram of an implementation of a system for capturing and formatting mainframe print data into logical events for off-device analysis, according to an embodiment.

FIG. 2 is a block diagram illustrating a first example of a compute device configuration for an implementation of a system for capturing and formatting mainframe print data into logical events for off-devices analysis.

FIG. 3 a block diagram illustrating a second example of a compute device configuration for an implementation of a system for capturing and formatting mainframe print data into logical events for off-device analysis.

FIG. 4 is a signal flow diagram illustrating an implementation of a system for capturing and formatting mainframe print data into logical events for off-device analysis, according to an embodiment.

FIG. 5 is a flowchart illustrating an implementation of a data collector for capturing and formatting mainframe print data into logical events, according to an embodiment.

FIG. 6 is a flowchart illustrating a method for determining mainframe operating system events based on identification of logical relations between datasets of mainframe operational data, according to an embodiment.

FIG. 7 is a flowchart illustrating a method for determining mainframe operating system events based on identification of self-supported datasets indicating a commencement and termination of a mainframe operating system event, according to an embodiment.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. It, however, will be clear and apparent that the subject technology is not limited to the specific details set forth herein and may be practiced without these specific details. In some instances, well-known structures and components are shown in block diagram form to avoid obscuring the concepts of the subject technology.

The terms “computer”, “processor”, “computer processor”, “compute device” or the like should be expansively construed to cover any kind of electronic device with data processing capabilities including, by way of non-limiting example, a digital signal processor (DSP), a microcontroller, a field programmable gate array (FPGA), an application specific integrated circuit (ASIC), or any other electronic computing device comprising one or more processors of any kind, or any combination thereof

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, can also be provided separately or in any suitable sub-combination.

High-variety of information assets is one of the main components of big data. Enterprise systems relying on mainframe technologies face multiple barriers to access and make available mainframe operational data to big data analytics tools. Big data analytics tools can infer valuable enterprise information by performing cross-source analysis, data mining, machine learning, meta-analysis, and other analytical techniques over big data. Enterprise intelligence can benefit from merging mainframe operational data with other machine data produced across distributed platforms, but merging mainframe data with other machine data is not a trivial task.

Mainframes serve a high number of users, processing thousands of transactions every second while maintaining centralized terabyte-size databases with datasets configured in specialized formats. An indiscriminate aggregation of mainframe datasets to big data repositories already storing complex and heterogeneous data can exacerbate common challenges faced by big data analytics tools. Some of these challenges include data processing speed, scalability, and use of computational resources.

When crucial mainframe datasets are not available for big data analytics tools' analysis enterprises miss opportunities to infer insights at enterprise micro- and macro-levels. Big data analytics tools can deliver more reliable and comprehensive enterprise insights by merging crucial mainframe datasets with other enterprise big data. Some examples of these insights include operational intelligence for enterprise security, faster trouble-shooting of errors encountered in production networks, and overall, support for better enterprise decision-making.

Some embodiments disclosed herein relate to methods and apparatus for capturing and formatting mainframe print data into logical events for off-device analysis. Such embodiments implement a system to capture mainframe operational data and format the data as logical events. Such embodiments execute computer-implemented methods for the logical correlation of multiple mainframe output lines into sets of logical events. The logical events in some instances are associated with mainframe operating system events. In other instances, the logical events can be associated with one or more transactions executed or determined at a mainframe's endpoint or at a compute device operatively coupled to a mainframe. Some embodiments, transmit the logical events to an off-device data processing system, or store the logical events in a buffer for the ingestion and analysis of an off-device data processing system. Alternatively, some embodiments can perform an analysis over the set of logical events locally with no support of an off-device data processing system.

Advantageously, some embodiments described herein, solve a two-fold problem. In one aspect, such embodiments parse mainframe outputs generated one line-at-a-time to determine correlations among outputs that are indicative of logical relations characteristic of, for example, a mainframe's operating system event. Based on such logical relations, these embodiments determine a set of logical events. In another aspect, these embodiments transform the determined set of logical events into a converted data format compatible with a format used by an off-device data processing system. Thus, in some embodiments, mainframe event data is integrated with non-mainframe machine data stored locally and/or in off-device data processing systems for big data analysis.

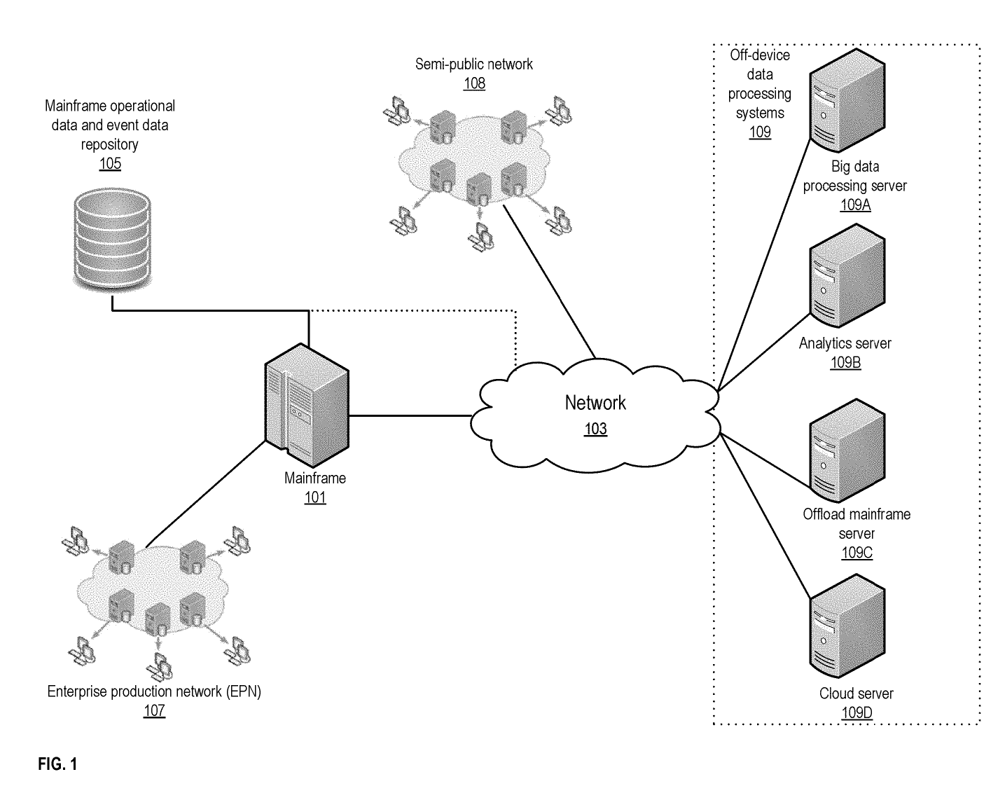

In some implementations, mainframe 101 discussed with reference to FIG. 1 includes a system (also referred to as a capture and format system “CAF system”) that can capture and format mainframe print data into logical events for off-device analysis. Mainframe 101 can provide services to users and/or compute devices operatively coupled to, for example, enterprise production network (“EPN”) 107 and semi-public network 108. Users and/or compute devices can log in simultaneously from a variety of sources such as, computer terminals, automated teller machines (ATMs), Internet websites, and other suitable sources and devices to complete one or more transactions.

Mainframe 101 executes time-sharing jobs in response to processing service requests made by authorized compute devices and/or authorized users. In some instances, mainframe 101 executes batch jobs and/or time-sharing jobs at regular times, according to predetermined schedules. Some specific examples of batch jobs include closing accounting books at month-end or copying disk files to tape for backup.

Mainframe 101 can run a mainframe operating system (OS), for example, z/VM, z/VSE™, Linux for System z®, z/OS, z/TPF and other suitable mainframe OS. Such an operating system can produce datasets indicating baseline OS activities running on mainframe 101, including inputs and outputs (I/O), network activity, software usage, error conditions, processor utilization, and other suitable OS activities.

EPN 107 can be, for example, a corporate network using processing services provided by mainframe 101. In some implementations, EPN 107 can include multiple sites nationwide and/or worldwide including local area networks (LAN), metropolitan area networks (MAN), wide area network (WAN) and other suitable networks.

Likewise, network 103 can include one or more types of communication networks. For example, communication networks can include Internet connectivity, a local area network (LAN), a wide area network (WAN), a metropolitan area network (MAN), various types of telephone networks (including, for example, Public Switch Telephone Network (PSTN) with Digital Subscriber Line (DSL) technology) or mobile networks (including for example Global System Mobile (GSM) communication, General Packet Radio Service (GPRS), Code Division Multiple Access (CDMA), and other suitable mobile network technologies.), or any combination thereof. Communication within network 103 can be realized through any suitable connection (including wired or wireless) and communication technology or standard (wireless fidelity (WiFi™), 4G™, long-term evolution (LTE™), or other suitable standard).

Semi-public network 108 can be, for example, a network operatively coupled to network 103 used by an enterprise to provide its own Internet services without allowing unauthorized access to EPN 107. In some instances, semi-public network 108 can include compute devices accessible to public Internet traffic, such as Web servers, file transfer protocol servers, e-mail servers, domain name system servers, and other suitable servers. In some instances, a firewall (not shown in FIG. 1) restricts access and services requested from the semi-public network 108 to EPN 107. In some other instances, mainframe 101 supports access and services requested from semi-public network 108 to EPN 107. In this case, mainframe 101 can produce datasets indicative of the aforementioned network activities, i.e., firewall restrictions and/or mainframe support processes. Mainframe 101 parses these and other type of mainframe data to determine mainframe events and convert such events into one or more formats compatible with off-device data processing systems.

EPN 107 and semi-public network 108 are some examples of networks operatively coupled to mainframe 101. Mainframe 101 can be similarly coupled to other networks (not shown), for example, (a) public networks owned and managed by authorized common carriers; (b) semi-private networks such as virtual private networks and software-defined networks; (c) private networks owned and managed by the same or other enterprise managing mainframe; and/or other suitable types of networks.

Off-device data processing systems 109 include big data processing server 109A, analytics server 109B, offload mainframe server 109C, and cloud server 109D. Server 109A-109D are examples of off-device data processing system; other embodiments can analogously operate with other types of off-device data processing systems not shown in FIG. 1. Off-device data processing systems 109 are communicatively coupled to mainframe 101, via network 103.

Big data processing server 109A can be, for example, a schema-free, with basic data availability, soft-state, and eventual data consistency (BASE) platform. Some examples of platforms as the ones represented by big data processing server 109A include Hadoop™, IBM® Informix®, MongoDB™, and other suitable platforms. In general, big data processing platforms include big data storage devices, servers, databases, big data management tools, business intelligence tools, and other big data management utilities. In some cases, big data processing platforms can support custom development of big data analytics tools, querying, and integration with other systems. In this case, big data processing server 109A can store mainframe operational data and other machine data produced across distributed platforms and/or across networks operatively coupled to mainframe 101.

Analytic server 109B can be, for example, an analytic processing service provider. Analytic server 109B can perform analysis of multidimensional data including mainframe operational data and other machine data. In some instances analytical server 109B can perform analysis on data stored in big data processing server 109A. In some other instances, analytic server 109B can retrieve data directly from mainframe 101 and/or directly from mainframe operational data and event data repository 105. Analytic server 109B can process multidimensional data to generate data in a form that is useful to make enterprise decisions. Some examples of analytic service providers as the ones represented by analytic server 109B include Splunk Cloud™, Google Analytics™, Siense™, and other suitable analytics service providers.

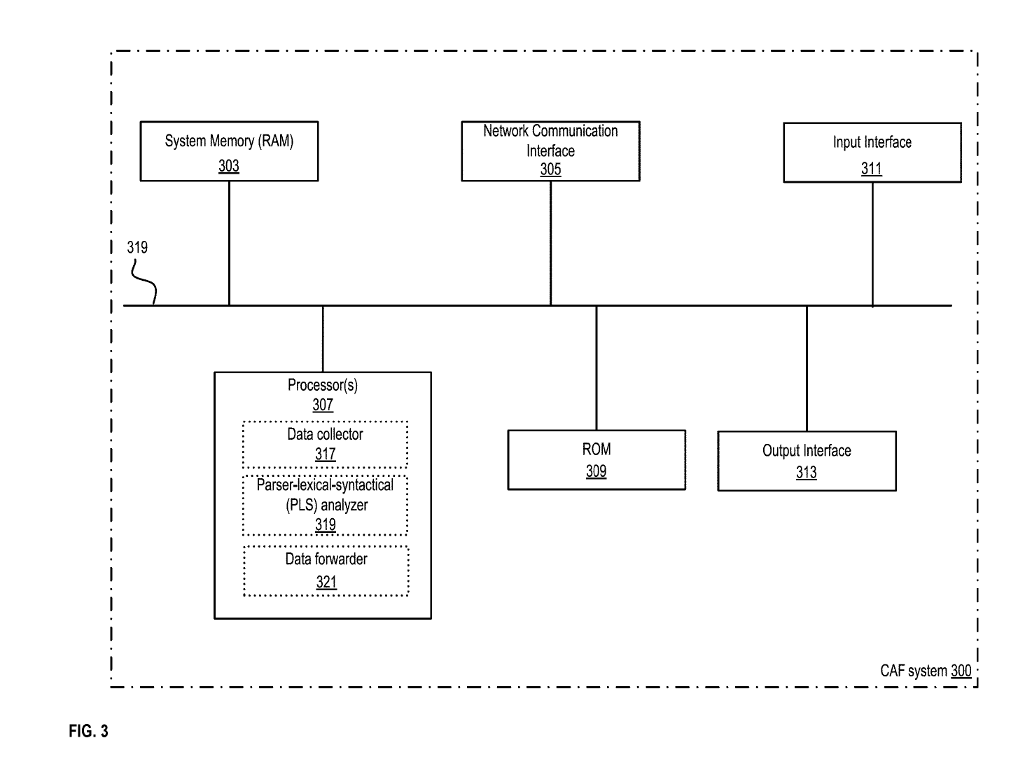

Offload mainframe server 109C can be any server used to reduce hardware, software, and processing costs incurred by mainframe 101. Mainframes generate and process high volumes of data; consequently, offload mainframe servers such as the one represented by server 109C can execute some batch processing and/or storage to mitigate computational costs incurred by mainframe 101. In some implementations, offload mainframe server 109C can perform similar functions as the functions performed by big data processing server 109A. In other implementations, offload mainframe server 109C can perform different and more specialized operations over mainframe operational data. For example, off load mainframe server 109C can implement a CAF system as the one discussed with reference to FIG. 3

A cloud server, for example, cloud server 109D can deliver big data processing services by providing all-inclusive big data solutions and services and/or provide remote backup services to mainframe 101.

In some implementations, mainframe 101 parses a data stream generated at the mainframe operative system. Such a data stream has mainframe operational data that is parsed by mainframe 101 to determine logical relations among uncorrelated datasets indicative of mainframe operating system events. Mainframe 101 generates a record data structure in a machine-readable format storing the determined logical relations, the related datasets, and identified mainframe operating system events. Such a record data structure is then sent and/or curated for ingestion by an off-device data processing system. Examples of off-device data processing systems include (a) mainframe operational data and event data repository 105; (b) big data processing server 109A; (c) analytics server 109B; (d) offload mainframe server 109C; (e) cloud server 109D; and (f) other suitable off-devices not shown in FIG. 1.

Data repository 105 stores mainframe operational data and log outputs in native format and converted formats. The converted formats are compatible with one or more of off-device data processing systems 109. In some implementations, off-device data processing systems 109 can send data requests to data repository 105. Subsequently, data repository 105 sends the requested data to a requestor off-device data processing system. Thereafter, the requestor data processing system integrates the received record data structure with other machine data, to perform, for example, big data analysis.

In some alternative implementations, mainframe 101 can send the data stream having mainframe operational data to an intermediate compute device as discussed with reference to FIG. 3. The intermediate compute device can determine logical relations among uncorrelated datasets indicative of mainframe operating system events. Thereafter, the intermediate compute device can generate record data structures based on the identified mainframe operating system events, send the record data structures and/or prepare them for ingestion by an off-device data processing system (e.g., off-device data processing systems 109) or other suitable system.

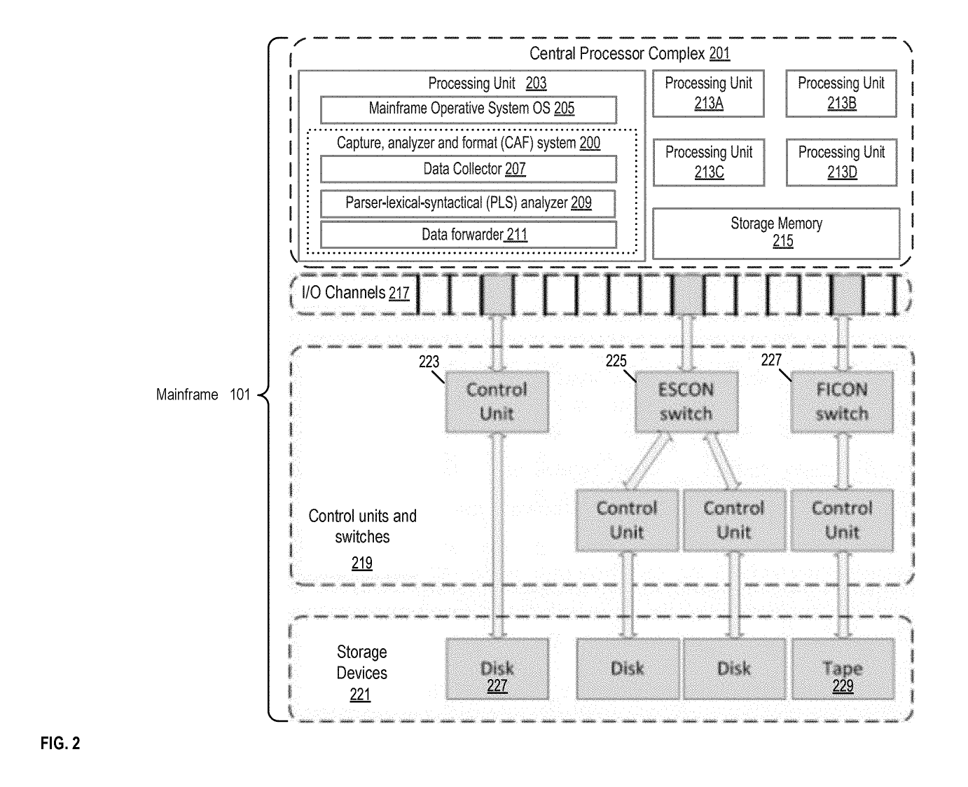

Some examples of internal components of some implementations of an apparatus for capturing and formatting mainframe print data into logical events for off-device analysis are described with reference to FIG. 2 and FIG. 3. In general, as shown with reference to FIG. 2, mainframes such as mainframe 101 include a central processor complex 201, I/O channels 217, an arrangement of control units and switches 219, and storage devices 221.

In some implementations, mainframe 101 has multiple processing units (PUs) arranged in central processor complex 201. Mainframes use specialized PUs for example, z10 mainframe processors or other suitable mainframe processors. Some processing units can be configured to process equivalent and/or interchangeably processing tasks, for example, processing units 213A-213D. In contrast, other processing units can be configured to process specific tasks, for example, processing unit 203 is configured to implement CAF system 200. In addition, processing unit 203 can be configured to implement mainframe operating system (OS) 205. Processors of the central processor complex 201 can retrieve and execute processor-executable instructions from, for example, storage memory 215.

CAF system 200 includes data collector 207, parser-lexical-syntactical (PLS) analyzer 209, and data forwarder 211. Mainframe OS 205 can include multiple machine executable programs (not shown in FIG. 2) to manage mainframe resources. Such mainframe resources include memories, processors, devices, file systems, and other suitable mainframe resources. Some examples of OS represented by mainframe OS 205 include zNM™, z/VSE™, Linux for System z®, z/OS™, z/TPF™, and other suitable mainframe operating systems.

Data collector 207 receives and/or fetches a data stream from mainframe OS 205 with mainframe log records in near real-time without disrupting the mainframe 101 operating environment. In some implementations data collector 207 can receive or fetch data in the order of terabytes including multiple log types. Some examples of mainframe logs include SYSLOGs, Job logs, OPERLOGs, Logrec Error Recording, Console Logs, Hardcopy Logs, and other suitable logs.

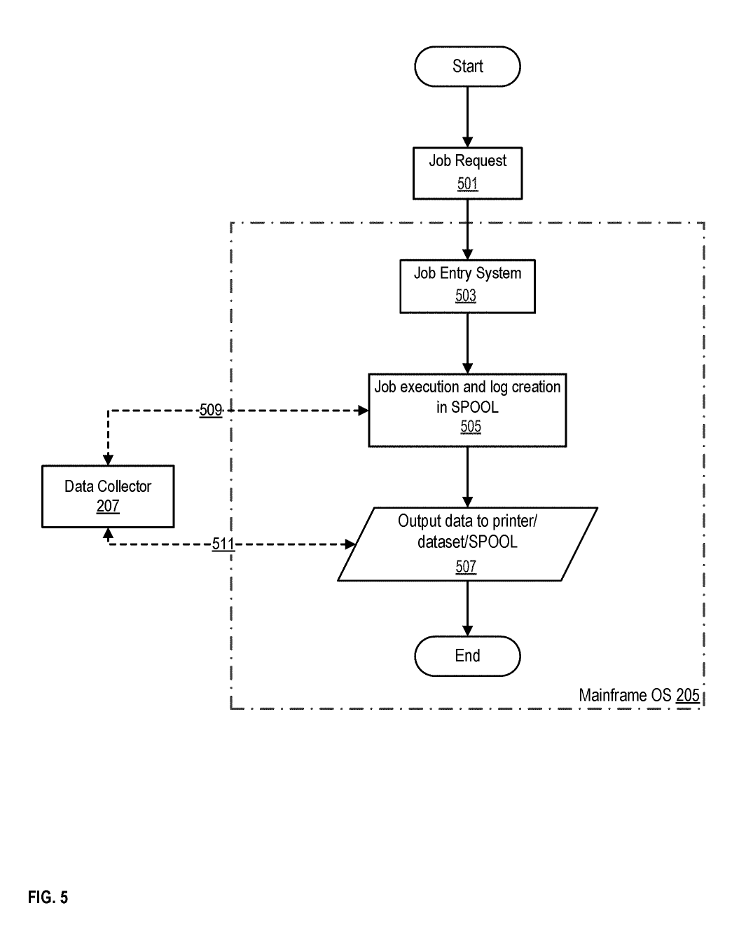

In some other implementations, data collector 207 can receive and/or fetch mainframe logs from a system management facility (SMF). A SMF is a mainframe operating system application use for the management of software services with tools for creating, monitoring, managing, and restarting services. A service is a long-lived software object (typically, a daemon) with a name, a clear error boundary, start and stop methods, and dependency relationships to other services on the system. A SMF can support collection of log files from mainframe OS 205 indicating mainframe activity. SMF can support data collector 207 in the acquisition of mainframe operational data including activity of I/O mainframe devices, network activity, software usage, error conditions, processor utilization, and other suitable operational data. Alternatively, in some implementations, data collector 207 does not need to rely on SMF and can receive and/or fetch mainframe log outputs directly from mainframe OS 205 and/or from a SYSOUT intermediate interface as discussed below with reference to FIG. 5.

Parser-lexical-syntactical (PLS) analyzer 209 processes log outputs retrieved and/or fetched by data collector 207. In some instances, mainframe OS 205 generates log outputs one line-at-a-time. Moreover, log outputs can span over multiple lines concealing start and end of log outputs. In some other instances, mainframe OS 205 can generate log outputs in other unstructured format types that similarly conceal boundaries between log outputs. PLS analyzer 209 parses mainframe OS log outputs gathered by data collector 207, and executes one or more lexical and/or syntactic analysis over log outputs and/or datasets to generate curated and well-defined logs in a target format compatible with off-device data processing systems. For example, in some instances, PLS analyzer 209 can produce a record data structure containing a log output and metadata such that the record data structure is ready for insertion into a table of a relational database. For another example, PLS analyzer 209 can produce a file in JavaScript Object Notation (JSON) containing a log output such that, the JSON is ready for insertion into a non-SQL database.

In some instances, PLS analyzer 209 activates an alarm upon a determination that a mainframe operating system event indicates an aleatory event associated with a compute device coupled to a mainframe. Such an aleatory event can include random mainframe operating system events and/or events with random variability or circumstance variability affecting, for example, mainframe 101 or other compute device coupled to mainframe 101. Examples of the aleatory events resulting in an activation of an alarm include errors occurring during a batch-processing tasks, errors detected before a job or task began, network security anomalies, not authorized access to a database or repository, unavailable resource (e.g., a process is locking a data needed to accomplish a task), deadlocks or timeouts, and other suitable aleatory events.

The aforementioned errors can further include other suitable logical errors and runtime errors. Logical errors occur when the program runs without crashing, but produces an incorrect result. Logical errors are caused by mistakes in a program's logic. In such a case, PLS analyzer 209 can flag a mainframe service or application that is likely to have the code that caused the logical error. Runtime errors occur when the code of a mainframe service or mainframe application is syntactically correct. The program, however, may exit unexpectedly during execution upon an encounter with a runtime error. Runtime errors are not detected during the program compilation, but rather they show when a particular code line is executed. In such a case PLS analyzer activates the alarm indicating the code line that has caused a runtime error upon identifying that a runtime error has been encountered.

In some other instances, PLS analyzer 209 activates an alarm upon a determination that an emergent property is developing and/or is affecting a group of compute devices operatively coupled to mainframe 101. An emergent property is a property affecting a complex system, such as the system shown in FIG. 1. Emergent properties are determined by the monitoring of, for example, operational data associated with a group of devices. Emergent properties are susceptible to fallacies of division, that is, assumptions made by reasoning that because a quality or attribute holds true for an element of a group or subsystem, must also be true for the whole group or subsystem. Emergent properties are a consequence of relationships between system components.

In some instances, emergent properties can be determined by, for example, identifying a mainframe operating system event indicating detrimental performance of a mainframe computing resource. In some instances, the determination can be based on a comparison of a value indicating a mainframe computing resource with a predetermined threshold value associated with such a mainframe computing resource. For instance, PLS analyzer 209 can activate an alarm when a control unit 221 is corrupted or degraded, causing disk 227 memory to reach a threshold associated with its maximum storage capacity. Accordingly, PLS analyzer 209 activates an alarm indicating the identified detrimental performance (i.e., disk 227 has reached its maximum storage capacity) and indicating that control unit 223 has or may have caused the detrimental performance. Notably, in some other instances, PLS 209 can activate the alarm by identifying that the rate at which control unit 223 sends data storage commands to disk 227 has reached a predetermined threshold rate.

Some examples of emergent properties that can cause PLS analyzer to activate an alarm include, (a) system reliability concerns caused by unexpected interactions between mainframe 101 with compute devices coupled to mainframe 101 or unexpected interactions between compute devices coupled to mainframe 101; (b) security properties measured as a function of the mainframe's ability to resist a cyber-attack; (c) reparability, i.e., a function of how easy it is to fix problems with the system once they have been identified; and (d) other suitable emergent properties. PLS analyzer 209 can determine the aforementioned and other emergent properties from identified mainframe operating system events.

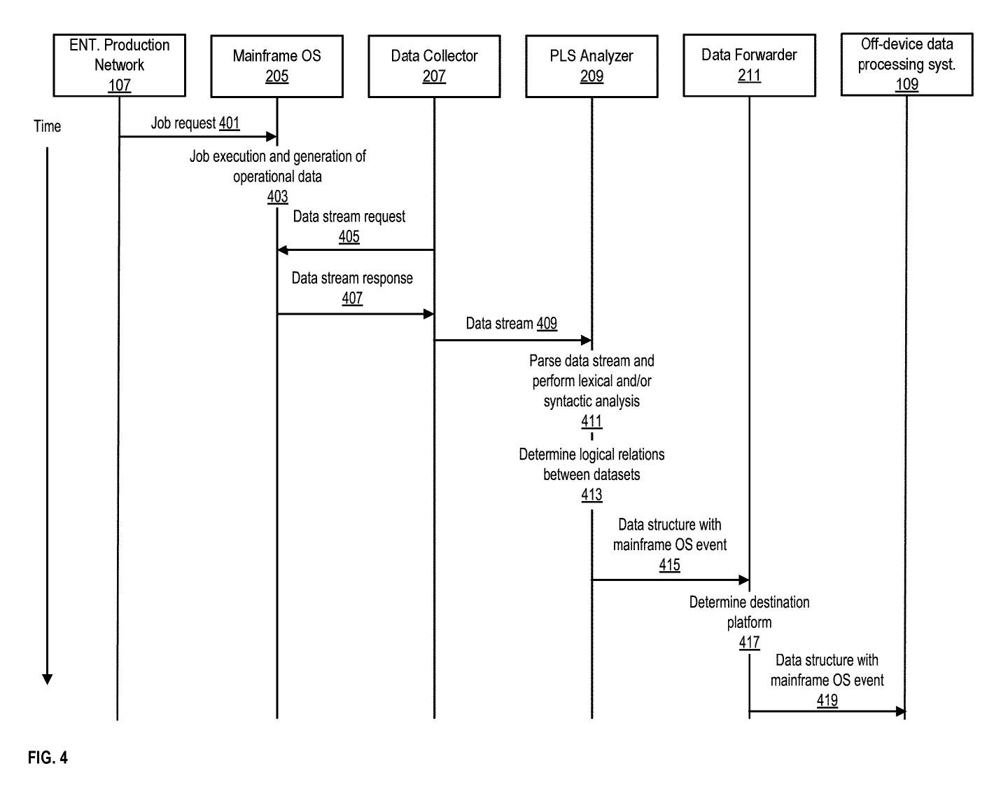

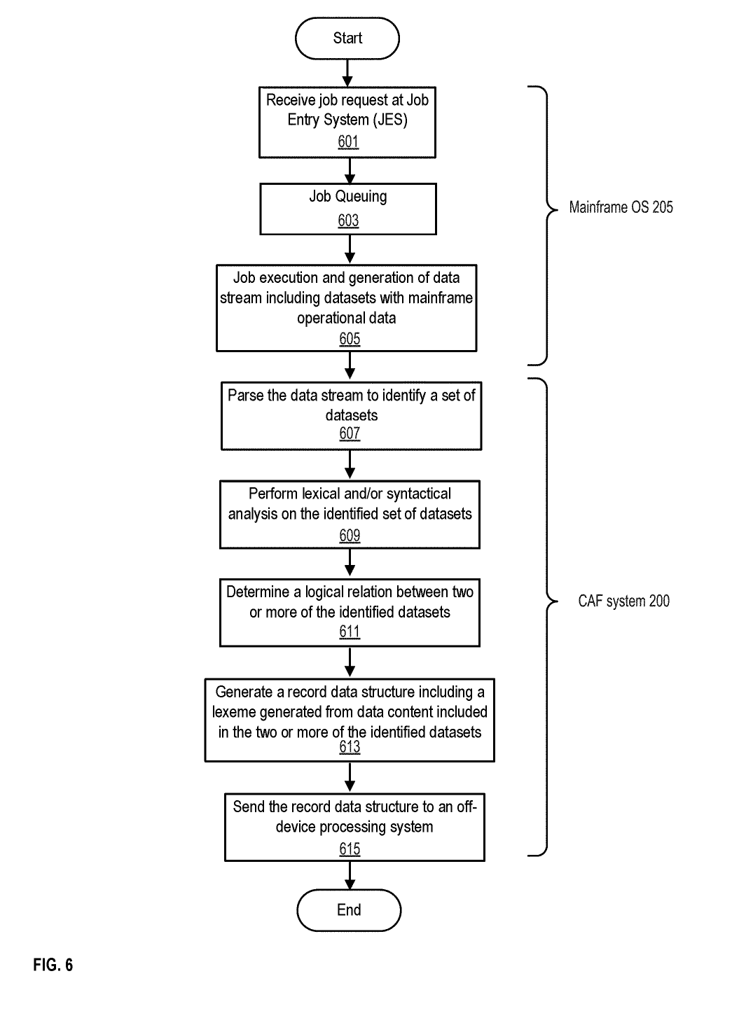

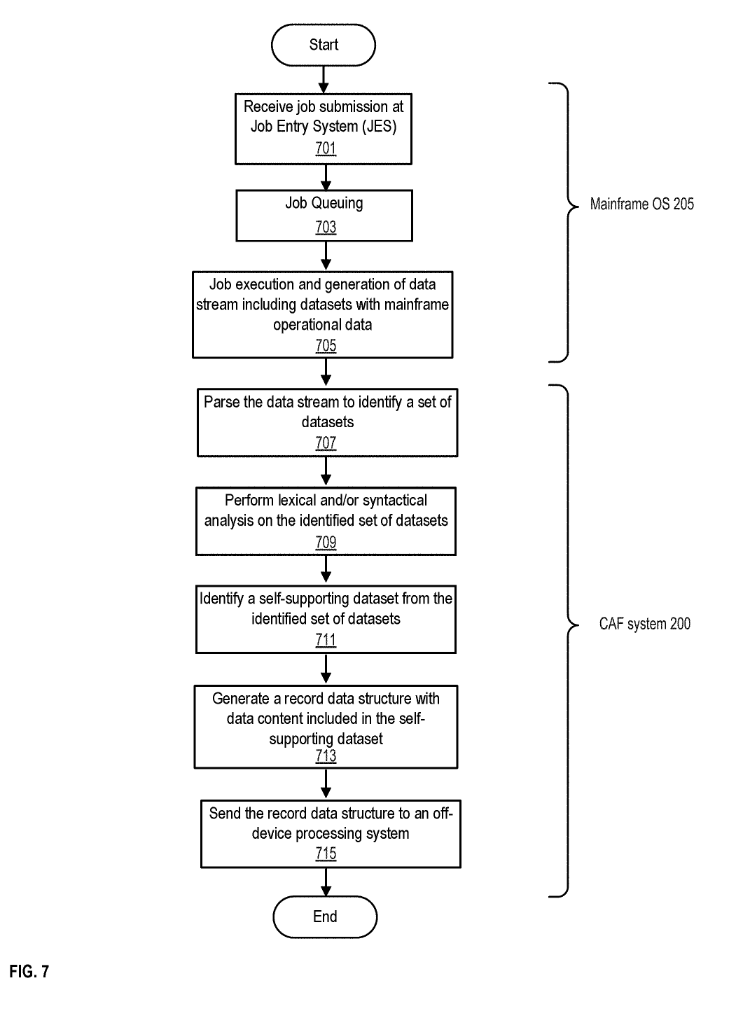

In some implementations, instead of activating an alarm, PLS analyzer 209 can flag a record data structure including mainframe operating system events that support a state of alarm. Thereafter, PLS analyzer 209 can deploy the flagged record data structure to an off-device processing system (e.g., off-device data processing system 109) or other suitable compute device. In this case, the off-device processing system can validate the alarm state based on an analysis of the mainframe operating system events included in the flagged record data structure and accordingly, activate or not activate an alarm. Further details regarding lexical and syntactic analyses executed by PLS analyzer 209 are discussed with reference to FIG. 4, FIG. 6, and FIG. 7.

In some implementations, data forwarder 211 can be operatively coupled to a data repository (e.g., mainframe operational data and event data repository 105 shown in FIG. 1). In some other implementations, data forwarder 211 sends log outputs in a record data structure directly to one or more off-device data processing systems in near-real time.

I/O channels 217 provide data and control paths between I/O devices and memories (e.g., storage devices 221). I/O channels 217 connect to control units, (e.g., control unit 223), either directly or via switches, for instance, enterprise systems connection (ESCON) switch 225 and fiber connection (FICON) switch 227.

Control units such as control unit 223 contain logic to work with a particular type of I/O device, like disk drives, tape drives, communication interfaces, and other suitable communication interfaces. Disks devices, e.g., disk 2279 can be a direct attached storage device (DASD) or other suitable storage device.

Tape devices, e.g., tape 229, provide storage at a lower cost than online disk storage for data that does not require high performance demands of online disk. Mainframe 101 uses tape devices to, for example, backup and restore of data into mainframe disks.

As discussed above, in some implementations, the CAF system for capturing and formatting mainframe print data into logical events can reside in a compute device separate from mainframe 101. FIG. 3 illustrates and example of such implementation. Bus 319 collectively represents system, peripheral, and/or chipset buses that communicatively connect numerous internal devices of CAF system 300. For instance, bus 319 communicatively couples processor 307 with read-only memory 309, system memory 303 (e.g., random access memory (RAM)), network communication interface 305, input interface 311, and output interface 313. From these various memory units, processor 307 can retrieve instructions to execute the processes described herein. Data collector 317, PLS analyzer 319, and data forwarder 321 are structurally and functionally analogous to data collector 207, PLS analyzer 209, and data forwarder 211 discussed with reference to FIG. 2

Processor 307 can be a single processor, a multi-core processor, or an arrangement of processors in different implementations. In some instances, processor 307 can be any suitable processor such as, for example, a general purpose processor, a field programmable gate array (FPGA), an application specific integrated circuit (ASIC), and/or other suitable hardware devices.

The read-only memory (ROM) 309 stores static data and instructions used by processor 307 and/or other components of the CAF system 300. System memory 303 can be a read-and-write memory device. System memory 303 stores some or all of the processor-executable instructions and data that processor 307 uses at runtime including processor-executable instructions to initiate and maintain the capturing and formatting of mainframe print data into logical events.

Input interface 311 enables users or other non-person entities to enter configuration files to, for example, enter parameters to perform lexical and syntactical analysis. Input devices used with input interface 311 include, for example, alphanumeric keyboards, pointing devices, touch screen interfaces and other suitable input devices.

Output interface 313 enables, for example, the display of images or alarms generated by CAF system 300. For example, in some implementations, CAF system 300 emits an alarm through a speaker connected to output interface 313 upon a determination of mainframe errors or security events. Similarly, a graphical information regarding a mainframe operational status can be display in a monitor operatively coupled to output interface 313.

Network communication interface 305 communicatively couples CAF system 300 to a network (e.g., network 103 shown in FIG. 1). Thus, CAF system 300 can be couple to or part of network 103 in FIG. 1 and receive log outputs from a mainframe device (e.g., mainframe 101 in FIG. 1). Likewise, CAF system 300 can send mainframe operating system events determined from received log outputs to off-device data processing systems.

FIG. 2 and FIG. 3 illustrate two different implementations of the CAF system for capturing and formatting mainframe print data into logical events. It should be understood, however, that in some other implementations, the embodiments described herein can be distributed in any configuration where a data collector such as data collector 207 and 317 (in FIG. 2 and FIG. 3) can communicatively access output logs produced by a mainframe and thereafter, the output logs are processed by a PLS analyzer and deploy by a data forwarder. For example, in some further embodiments, the subject technology or some aspects of the subject technology can be implemented in an off-site data processing system shown in FIG. 1, including big data processing server 109A, analytics server 109B, offload mainframe server 109C, cloud server 109D, or other suitable compute device.

A further advantage of the subject technology is its capacity to collect, transform, and forward mainframe log data, such as SMF logs to numerous off-device data processing systems. It is appreciated, that the subject technology supersedes the need to implement a dedicated system to monitor mainframe operational data isolated from other machine data produced by an enterprise.

An illustration of a signal flow of a CAF system for capturing and formatting mainframe log outputs as logical events is discussed below with reference to FIG. 4. In the example illustrated in FIG. 4, EPN 107 sends a job request 401 to a mainframe (e.g., mainframe 101 in FIG. 1). The job request 401 can be, for example, a request to process a batch load or other suitable job request.

Mainframe OS 205 receives the job request 401, and executes, at 403, the requested job while generating operational data (e.g., log records) associated, for example, with mainframe resources used during the job execution. In some implementations, data collector 207 sends a data stream request 405 to mainframe OS 205 to retrieve the mainframe OS operational data generated at 403. Thereafter, mainframe OS 205 routes or sends a data stream response 407 to data collector 207. In some implementations, data collector 207 can retrieve operational data generated by mainframe OS 205 from, for example, a SYSOUT interface further discussed with reference to FIG. 5

Data collector 207 sends the data stream 409 to PLS analyzer 209. Data stream 409 can include multiple mainframe output lines; each mainframe output line formed by a set of alphanumeric and/or typographical symbols. PLS analyzer 209 executes lexical and/or syntactic analysis at 411 on the data stream 409 to determine mainframe operating system events.

In some implementations, the types of mainframe operating system events that PLS analyzer 209 is configured to identify can be specified by a user or non-person entity. For example, a user or non-person entity can send a digital signal to CAF system 200 specifying the types of mainframe operating system events that PLS analyzer 209 should identify and capture from a data stream. Examples of mainframe operating system events can be related to invalid inputs, conversion errors, processing operations, storing operations, and other suitable events included in the data stream. The events included in the data stream can be associated with events occurring at mainframe 101, repository 105, EPN 107, semi-public network 107, (shown in FIG. 1) and other events occurring at compute devices coupled to mainframe 101 not shown in FIG. 1.

In some instances, PLS analyzer 209 executes syntactic analysis extracting tokens from a mainframe output line to determine the structure of the mainframe output line. The structure of a mainframe output line includes a hierarchy of associated symbols. In some instances, PLS analyzer 209 can divide a mainframe output line into basic symbols (e.g., tokens) that as a whole indicate a well-defined mainframe operating system event. PLS analyzer 209 can identify a mainframe operating system event from a single mainframe output line when such an event is well-defined by the basic symbols included in the single mainframe output line. For example, PLS analyzer 209 can identify an event based on a combination of markup language tags included in a single mainframe output line (e.g., start and end tag).

In some instance, PLS analyzer 209 executes lexical analysis extracting individual words or lexemes from an input stream (e.g., data stream 409) and passing corresponding tokens back to a PLS parser or syntactic analyzer. PLS parser forwards the tokens to a keyword recogniser, an identifier recognizer, a numeric constant recogniser, a string constant recogniser, or other suitable type of lexical or syntactic recognizer. The type and number of recognizers used by PLS analyzer 209 can be based on a set of disambiguating rules. Examples of such disambiguating rules include “reserved words”, which cannot be used as identifiers. Thus, if a string can be either a keyword or an identifier, a recognizer would classify the string as a keyword. For another example, a rule can specify a maximal munch or segment, where if the PLS analyzer 209 can interpret a string as a single token or a sequence of tokens, the former interpretation is generally assumed.

In some instances, PLS analyzer 209 determines logical relations between two or more mainframe output lines, which as a whole indicate a single mainframe operating system event. Such logical relations can be determined through lexical and/or syntactical analysis. PLS analyzer 209 can determine semantics associated with a mainframe operating system event based on lexical analysis of single output lines or single datasets. PLS analyzer 209 can execute lexical analysis to determine, for example, a logical relation between two or more single output lines or single datasets recognizing indents, carriage control/return symbols, and other suitable symbols. Some single output lines or single datasets can include one or more carriage control/return symbols and/or indents, these type of symbols convey a meaning about mainframe operating system events. For example, a mainframe operating system event can include multiple single lines or single datasets. In some instances, logical relations such as hierarchical, equivalence, associative, and other suitable relations among elements of an operating system event can be determined through lexical analysis. Accordingly, PLS analyzer 209 tracks these and other symbols to convey their meaning in a format and/or machine language compatible with a destination source.

In some implementations, PLS analyzer 209 instantiates a record data structure in a predetermined or converted format compatible with an off-device data processing system or other suitable destination source. Next, PLS analyzer 209 initializes the record data structure with values to denote an identified mainframe operating system events.

At 415, PLS analyzer 209 sends the initialized record data structure to data forwarder 211. Data forwarder 211 determines destination platform(s), for example, one or more of off-device processing systems shown at 109 in FIG. 1, and sends, at 419, the record data structure to predetermined platform(s).

FIG. 5 illustrates a further example of an implementation of data collector 207. In some instances, mainframe OS 205 receives a request for a batch-processing task (e.g., job request 501) specified in Job Control Language (JCL) or other suitable programming language. In general, mainframes perform batch-processing tasks to conserve system resources and allow for any modifications to data before being processed. For example, banks will batch process all their transactions once every hour instead of processing each transaction immediately.

In this example, mainframe OS 205 uses job entry system (JES) 503 to receive and schedule job requests for execution; other suitable technologies to communicate with mainframe OS, however, can be analogously used. JES is the component of the operating system that provides supplementary job management, data management, and task management functions such as scheduling, control of job flow, and the reading and writing of input and output streams on auxiliary storage devices, concurrently with job execution. In some instances, mainframe OS 205 receives job request 501 from; for example, a compute device connected to enterprise production network 107 (shown in FIG. 1). In other instances, mainframe OS 205 receives job request 501 from other suitable compute device communicatively coupled to mainframe OS 205.

Job entry system 503 determines a priority of the requested job based on parameters received in job request 501. Examples of such parameters include CLASS, PRTY, and other suitable parameters. When a requested job reaches its highest priority, job entry system 503 takes up the job for execution at 505. During job execution 505, mainframe OS 205 generates a data stream with output data associated with the tasks, log outputs, and other mainframe operational data. Next, mainframe OS 205, at 507, redirects or outputs the data stream to a destination system, for example, mainframe operational data and event data repository 105 (shown in FIG. 1), a simultaneous peripheral operations online (SPOOL) system, a dataset or other suitable destination system or data structure.

In some implementations, data collector 207 retrieves the data stream, at 509, with data generated at 505. In some other implementations, data collector 207 retrieves the data stream at 511 while mainframe OS 205 redirects the data stream to a destination system. Once the data collector 207 receives the data stream, the stream is redirected to the PLS analyzer 209 (not shown in FIG. 5) and the process continues as discussed with reference to FIG. 4.

FIG. 6 and FIG. 7 show two further examples for capturing and formatting mainframe print data into logical events for off-device analysis. The example described with reference to FIG. 6 discusses determination of logical relations between mainframe operational datasets received separately in a data stream. The example described with reference to FIG. 7 discusses the identification of a self-supporting mainframe operational dataset.

In FIG. 6, a mainframe OS 205 receives at 601 a job request at a mainframe OS job entry system. Job entry system determines a priority for the received job request and based on the determined priority stores at 603 the job request in a job queuing data structure or memory. Mainframe OS executes the requested job, for example, when the requested job reaches its highest priority. In addition, at 605, the mainframe OS 205 generates a data stream including datasets or mainframe output lines with mainframe operational data, data logs, and/or other data associated with the execution of tasks. As shown in Example #1 below:
1. Analysis reveals possible lookup error for given address
2. Entered address is
3. 1234 Main Street
4. Anytown, USA
5. Postal processing changed the address to
6. 1234 Main St.
7. Anytown, USA 012345-6789
8. This is a message from the current processing.
9. Invalid credit card information entered.
10. Credit card is reported stolen.

As discussed with reference to FIG. 4 and FIG. 5, in some implementations, CAF system 200 retrieves or intercepts a data stream generated at 605, via data collector 207 (shown in, for example, FIG. 4). In some other implementations, the mainframe OS 205 pushes the data stream to CAF system 200. CAF system 200 parses, at 607, the data stream to identify a set of datasets or mainframe output lines. Example #1 is a segment of such a data stream showing ten datasets or mainframe output lines. CAF system 200 performs, at 609, lexical and/or syntactical analysis on the identified set of datasets or mainframe output lines.

As discussed above with reference to, for example, FIG. 2, CAF system 200 determines, at 611, logical relations among two or more uncorrelated datasets or mainframe output lines that are indicative of mainframe operating system events. For the segment of the data stream shown in Example #1, CAF system 200 determines two mainframe operating system events. The first mainframe operating system event indicates an execution of a formatting operation on an address entered as part of a job request (lines 2-4 in Example #1). CAF system 200 generates the first event based on lexical analysis of lines 1-8 of Example #1. The second mainframe operating system event indicates a use of a stolen credit card. In this instance, CAF system 200 generates the second event based on lexical analysis of lines 8-10 of Example #1. In Example #1, CAF system 200 can differentiate between two or more mainframe operating system events by recognizing indents, and carriage control/return symbols. For example, the indent space in lines 1 and 8 indicates the beginning of mainframe operating system events. Indent spaces that are larger than the indent space shown in lines 1 and 8 indicate attributes of a mainframe operating system event e.g., indent spaces of lines 2-7 and lines 9 and 10.

CAF system 200 generates, at 613, a record data structure in a machine-readable format including data of the first and second mainframe operating system events. For example, data representing the first event can include (a) an event type identifier indicating a formatting operation was executed on input data (in this case, an address); (b) the address that was originally entered (i.e., lines 2-4 in Example #1); (c) an identifier of the formatting operation (i.e., line 5 in Example #1); and (d) the formatted address (i.e., lines 6-7 in Example #1). Moreover, at 613, CAF system 200 can generate further structural and/or descriptive metadata such that the record data structure becomes compatible with a format of an off-device processing system or other suitable destination source. For example, CAF system 200 can divide line 7 of Example #1 in three fields. A first field tagged with descriptive metadata indicating that “Anytown” is a city, a second field tagged with descriptive metadata indicating that “USA” is a country, and a third field tagged with descriptive metadata indicating that “ 012345-6789” is a postal code.

In some instances, CAF system 200 can aggregate structural metadata to record data structures of identified mainframe operating system events. For example, the record data structure generated at 613 can encapsulate a first event indicating an execution of a formatting operation on an entered address (lines 1-7 of Example #1), a second event indicating a use of an invalid credit card (lines 8-10 of Example #1), and a structural metadata field linking the first event with the second event to, for example, indicate that the invalid credit card was entered with a billing address corresponding to the address entered and formatted in the first event.

In some further instances, CAF 200 system can include other suitable metadata in each of the mainframe operating system events encapsulated in record data structure(s) including data types, compression ratios, tracking of system responses, permissions, authentication and security data, specialized indexes, and other suitable metadata. In some instances, the aggregated metadata enables a seamless integration of the record data structures with machine data stored in off-device processing systems or other suitable destination sources. Record data structures can be customized via the aggregated metadata to be readily available to respond to search queries executed, for example, in off-device processing systems 109 (shown in FIG. 1), repository 105 (also shown in FIG. 1) and other suitable destination data sources. Likewise, CAF system 200 can generate record data structures in compact forms, for example, with a minimum amount of data and metadata required to be integrated with other machine data.

In some implementations, a record data structure can include a lexeme generated from data content included in the two or more uncorrelated datasets or mainframe output lines that are indicative of a mainframe operating system event. Such a lexeme indicates a basic lexical unit in a given language. A lexeme has a semantic meaning and can include a sequence of one or more elements (e.g., words, alphanumeric characters, output lines and other suitable symbols). If separated, the elements of the lexeme do not convey the meaning of the whole; for example, lexemes can indicate an identifiable mainframe operating system event. For the purposes of determining mainframe operating system events, mainframe output lines 1-7 represent a first lexeme indicating a formatting operation and mainframe output lines 8-10 represent a second lexeme indicating a use of an invalid credit card.

At 615, CAF system 200 sends the record data structure to an off-device processing system such the systems shown at 109 in FIG. 1, repository 105 also shown in FIG. 1, and/or other suitable destination source.

The record data structure sent at 615, includes mainframe operating system events that are compact, readily searchable, easily managed, and denote a complete mainframe operating system event. Consequently, the produced record data structures eases the burden of providing semantic meaning to single mainframe output lines and/or single datasets ingested and stored one-at-a-time in off-device processing systems.

Additional aspects of CAF system 200 are provided in the flowchart illustrated in FIG. 7. The sequence of operations 701, 703, 705, 707, and 709, in FIG. 7 are functionally analogous to operations 601, 603, 605, 607, and 609 discussed above with reference to FIG. 6. At 711, however, CAF system 200 identifies a self-supporting dataset from the identified set of datasets. A self-supporting dataset can be a single mainframe output line that unambiguously identifies a mainframe operating system event. For example, a single output line or single dataset can include a lexeme indicative of an operating system event as shown below in Example #2.

<JAVA conversion error>. . . invalid numeric data in cost field </JAVA conversion error>

PLS analyzer 209 (shown in FIG. 2) can determine whether such an output line or dataset denotes a well-defined operating system event. The determination of a denoted well-defined operating system event can be based on, for example, syntactic analysis over basic symbols included in the single mainframe output line or single dataset. In some instances, PLS analyzer 209 can determine that a single output line or single dataset denotes a well-defined operating system event by identifying a commencement symbol e.g., (<JAVA conversion error>) and a termination symbol (e.g., </JAVA conversion error>) associated with a mainframe operating system event.

At 713, CAF system 200 generates a record data structure in a machine-readable format compatible with a native format of an off-device processing system or other suitable destination source. The record data structures includes content generated from the self-supporting dataset or single output line to denote the mainframe operating system event. Thereafter, CAF system 200 sends, at 715, the record data structure to, an off-device processing system such the systems shown at 109 in FIG. 1, repository 105 also shown in FIG. 1, and/or other suitable destination source. CAF system 200 can aggregate structural and descriptive metadata to the record data structure as previously discussed with reference to FIG. 6. Accordingly, the record data structure generated at 715 can have analogous functional and structural properties as the ones described with reference to record data structure generate at 615 in FIG. 6.

As discussed with reference to FIG. 6, the record data structure sent at 715 includes mainframe operating system events that are compact, readily searchable, easily managed, and denote a complete mainframe operating system event. Consequently, the produced record data structure eases the burden of providing semantic meaning to single mainframe output lines and/or single datasets ingested and stored one-at-a-time in off-device processing systems.

While various embodiments have been described above, it should be understood that they have been presented by way of example only, and not limitation. Where methods and/or schematics described above indicate certain events and/or flow patterns occurring in certain order, the ordering of certain events and/or flow patterns may be modified. While the embodiments have been particularly shown and described, it will be understood that various changes in form and details may be made. Additionally, certain of the steps may be performed concurrently in a parallel process when possible, as well as performed sequentially as described above. Although various embodiments have been described as having particular features and/or combinations of components, other embodiments are possible having any combination or sub-combination of any features and/or components from any of the embodiments described herein. Furthermore, although various embodiments are described as having a particular entity associated with a particular compute device, in other embodiments different entities can be associated with other and/or different compute devices.

It is intended that the systems and methods described herein can be performed by software (stored in memory and/or executed on hardware), hardware, or a combination thereof. Hardware modules may include, for example, a general-purpose processor, a field programmable gates array (FPGA), and/or an application specific integrated circuit (ASIC). Software modules (executed on hardware) can be expressed in a variety of software languages (e.g., computer code), including Unix utilities, C, C++, Java™, JavaScript, Ruby, SQL, SAS®, the R programming language/software environment, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code. Each of the devices described herein can include one or more processors as described above.

Some embodiments described herein relate to devices with a non-transitory computer-readable medium (also can be referred to as a non-transitory processor-readable medium or memory) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

1. An apparatus, comprising:
a processor; and
a memory storing instructions which, when executed by the processor, causes the processor to:
fetch, via a system management facility coupled to a mainframe operating system, a data stream including a plurality of datasets with mainframe operational data indicative of at least one of: activity of mainframe input devices, activity of mainframe output devices, mainframe software usage, mainframe error conditions, or mainframe processor utilization, each dataset from the plurality of datasets being uncorrelated to at least one other dataset from the plurality of datasets;
parse the data stream to identify a set of datasets from the plurality of datasets;
determine a logical relation between at least two datasets from the set of datasets;
generate a data structure including (1) a lexeme produced based on the at least two datasets and the logical relation, and (2) structural and/or descriptive metadata such that the data structure is compatible with a machine-readable format supported by a compute device external to the apparatus, the lexeme indicating a mainframe operating system event and
send the data structure to the compute device.

2. The apparatus of claim 1, wherein the memory storing instructions which, when executed by the processor, further causes the processor to:
receive a digital signal indicative of at least one type of dataset to be identified in the data stream by the apparatus.

3. (canceled)

4. The apparatus of claim 1, wherein the memory storing instructions which, when executed by the processor, further causes the processor to:
activate an alarm upon a determination that the mainframe operating system event indicates a detrimental performance of at least one mainframe computing resource, the determination based on a predetermined threshold corresponding to a mainframe performance metric value.

5. The apparatus of claim 1, wherein the memory storing instructions which, when executed by the processor, further causes the processor to:
activate an alarm upon a determination that the mainframe operating system event indicates a detrimental performance of at least one software application operatively coupled to a mainframe associated with the mainframe operating system event, the determination based on a logical error associated with the at least one software application.

6. The apparatus of claim 1, wherein the memory storing instructions which, when executed by the processor, further causes the processor to:
activate an alarm upon a determination that the mainframe operating system event indicates a detrimental performance of at least one software application operatively couple to a mainframe associated with the mainframe operating system event, the determination based on a runtime error of the at least one software application, the runtime error associated with a user interaction with the at least one software application.

7. The apparatus of claim 1, wherein the compute device is a first compute device and the memory storing instructions which, when executed by the processor, further causes the processor to:
activate an alarm upon a determination that the mainframe operating system event indicates an aleatory event associated with a second compute device coupled to a mainframe associated with the mainframe operating system event.

8. The apparatus of claim 1, wherein the data structure includes information indicative of a commencement and a termination of the mainframe operating system event.

9. The apparatus of claim 1, wherein the logical relation between the at least two datasets is determined at least in part on a syntactic analysis of data content included in the at least two datasets.

10. The apparatus of claim 1, wherein the logical relation between the at least two datasets is determined at least in part on a lexical analysis of data content included in the at least two datasets.

11. (canceled)

12. The apparatus of claim 1, wherein the data structure is a first data structure and the mainframe operating system event is a first mainframe operating system event, the memory storing instructions which, when executed by the processor, further causes the processor to:
identify a self-supporting dataset from the identified set of datasets, based on a lexical analysis and/or a syntactic analysis of content data included in the self-supporting dataset the self-supporting dataset unambiguously indicating a second mainframe operating system event; and
generate a second data structure based on the content data included in the self-supporting dataset, the second data structure includes information indicative of a commencement and a termination of the second mainframe operating system event.

13. The apparatus of claim 12, wherein the lexeme is a first lexeme and the second data structure includes a second lexeme generated from data included in the self-supporting dataset.

14. A non-transitory computer-readable medium comprising instructions which, when implemented by a processor, cause the processor to:
fetch from a mainframe operating system, via a simultaneous peripheral operations online system at a mainframe, a data stream including a plurality of datasets with mainframe operational data indicative of at least one of: activity of mainframe input devices, activity of mainframe output devices, mainframe software usage, mainframe error conditions, or mainframe processor utilization, each dataset from the plurality of datasets being uncorrelated to at least one other dataset from the plurality of datasets;
parse the data stream to identify a set of datasets from the plurality of datasets;
identify a self-supporting dataset from the set of datasets, based on a lexical analysis and/or a syntactic analysis, the self-supporting dataset unambiguously indicates a mainframe operating system event;
generate a data structure based on data included in the self-supporting dataset, the data structure includes (1) information indicative of a commencement and a termination of a the mainframe operating system event and (2) structural and/or descriptive metadata such that the data structure is compatible with a machine-readable format supported by a compute device different from the mainframe; and
send the data structure to the compute device.

15. The non-transitory computer-readable medium of claim 14, further causing the one or more computers to:
include a lexeme in the data structure, the lexeme generated from the data included in the self-supporting dataset.

16. A method comprising:
fetching, via a compute device, a data stream from a mainframe operating system, the data stream including a plurality of datasets with mainframe operational data indicative of at least one of: activity of mainframe input devices, activity of mainframe output devices, mainframe software usage, mainframe error conditions, or mainframe processor utilization, each dataset from the plurality of datasets being uncorrelated to at least one other dataset from the plurality of datasets;
parsing the data stream to identify a set of datasets from the plurality of datasets;
determining a logical relation between at least two datasets from the identified set of datasets that unambiguously indicates a mainframe operating system event;
generating a data structure including a lexeme indicative of the mainframe operating system event based on content of the at least two datasets and the logical relation; and
activate an alarm upon a determination that the lexeme indicates a detrimental performance of at least one mainframe computing resource.

17. The method of claim 16, wherein the logical relation between the at least two datasets is determined at least in part on a syntactic analysis of content data included in the at least two datasets.

18. The method of claim 16, wherein the logical relation between the at least two datasets is determined at least in part on a lexical analysis of content data included in the at least two datasets.

19. (canceled)

20. The method of claim 16, wherein the alarm is associated with an emergent property affecting at least two compute devices operatively coupled to a mainframe associated with the mainframe operating system event.

21. The method of claim 16, wherein the data structure is a first data structure, and the mainframe operating system event is a first mainframe operating system event and the method further comprising:
identifying a self-supporting dataset from the set of datasets, based on a lexical analysis and/or a syntactic analysis of content data included in the self-supporting dataset the self-supporting dataset unambiguously indicating a second mainframe operating system event; and
generating a second data structure based on the content data included in the self-contained dataset, the data structure includes information indicative of a commencement and a termination of the second mainframe operating system event.

22. The method of claim 21, wherein the lexeme is a first lexeme, and the second data structure includes a second lexeme generated from the content data included in the self-supporting dataset.

23. The apparatus of claim 1, wherein the mainframe operating system event indicated by the lexeme includes at least one of: an error occurring during a batch-processing tasks, an error detected before a task is executed by a mainframe, network security anomalies of a network coupled to the mainframe, not authorized access to a repository coupled to the mainframe, unavailability of a mainframe resource, deadlock associated with a task executed by the mainframe, or timeouts of tasks executed by the mainframe.

24. The apparatus of claim 1, wherein the structural and/or descriptive metadata includes at least one of: a data type, a value indicative of data compression ratios, data access permission, data authentication, or security data.

25. The method of claim 16, wherein the compute device fetches the data stream from the mainframe operating system via a simultaneous peripheral operations online system.
